(19) United States
(12) Patent Application Publication
(10) Pub. No.: US 2024/0119379 A1
(43) Pub. Date: Apr. 11, 2024

(54) SYSTEMS AND METHODS FOR AUTOMATICALLY SCHEDULING AIRCRAFT PILOT TRAINING RESOURCES

(71) Applicant: THE BOEING COMPANY, CHICAGO, IL (US)

(72) Inventors: David Hellerström, Varberg (SE); Pontus Ekh, Landvetter (SE); Adam Wojciechowski, Gothenburg (SE); Mattias Slabanja, Gothenburg (SE); Erik Sedhed, Gothenburg (SE); Marius Magearu, Montreal Quebec (CA)

(73) Assignee: THE BOEING COMPANY, CHICAGO, IL (US)

(21) Appl. No.: 17/961,729

(22) Filed: Oct. 7, 2022

(51) Int. Cl. G06Q 10/06

(52) U.S. Cl. CPC G06Q 10/06314

(57) ABSTRACT

A system and a method include a resource scheduling control unit configured to receive inputs including information regarding pilots and pilot training resources, generate schedules for the pilots based on the inputs, and output the schedules to one or more user interfaces.

### FIELD OF THE DISCLOSURE

Examples of the present disclosure generally relate to systems and methods for automatically scheduling aircraft pilot training resources.

### BACKGROUND OF THE DISCLOSURE

Aircraft are used to transport passengers and cargo between various locations. Numerous aircraft depart from and arrive at a typical airport every day.

Aircraft pilots undergo extensive education and training. Such training includes numerous in person classes, flight simulator training, and the like. Typically, the process of scheduling training resources for pilots is time consuming and labor intensive. For example, certain aircraft operators manage schedules via workbooks. One or more individuals manually construct schedules. In general, a known manual scheduling process takes three works or more to complete by numerous individual scheduling specialists. As can be appreciated, the process of manually scheduling numerous resources for numerous individual pilots is time consuming, complicated, and can be overwhelming for certain individuals.

### SUMMARY OF THE DISCLOSURE

A need exists for a system and a method for efficiently, effectively, and optimally scheduling pilot training resources for individuals. With that need in mind, certain examples of the present disclosure provide a system including a resource scheduling control unit configured to: receive inputs including information regarding pilots and pilot training resources, generate schedules for the pilots based on the inputs, and output the schedules to one or more user interfaces.

In at least one example, the pilot training resources include one or more of: full flight simulators, procedural trainers, flight training devices, and/or classrooms.

In at least one example, the inputs include one or more of resource data including information regarding availability and capacity for the pilot training resources, times and dates when the pilots are not available for scheduling, information regarding training already complete, and training that still needs to be completed for the pilots, information as to individual pilots who can, or cannot, train together in relation to one or more of pilot training resources, labor rules, quality rules, usage costs, travel costs, and/or qualification and availability for instructors for one or more of the pilot training resources.

Certain examples of the present disclosure provide a method including receiving, by a resource scheduling control unit, inputs including information regarding pilots and pilot training resources; generating, by the resource scheduling control unit, schedules for the pilots based on the inputs; and outputting, by the resource scheduling control unit, the schedules to one or more user interfaces.

Certain examples of the present disclosure provide a non-transitory computer-readable storage medium including executable instructions that, in response to execution, cause one or more control units including a processor, to perform operations including: receiving inputs including information regarding pilots and pilot training resources; generating schedules for the pilots based on the inputs; and outputting the schedules to one or more user interfaces.

### BRIEF DESCRIPTION OF THE DRAWINGS

FIG. 1 illustrates a schematic block diagram a system for scheduling pilot training resources, according to an example of the present disclosure.

FIG. 2 illustrates a flow chart of a method for scheduling pilot training resources, according to an example of the present disclosure.

FIG. 3 illustrates a schematic block diagram of a control unit, according to an example of the present disclosure.

FIG. 4 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Certain examples of the present disclosure provide systems and methods for automatically scheduling training resources for pilots (including current pilots, and individuals studying and/or training to be pilots). The systems and methods include a resource scheduling control unit that generates schedules for the pilots. In at least one example, the schedules are based on simulator capacity given as a set of available simulator slots, identified training needs, expressed as set of curricula variants for crew and target date for conversion, and needed volumes for different recurrent training over different crew groups and time periods. In at least one example, the schedules include course module sequences for both named and anonymous trainees, mapped to training device slots. The resource scheduling control unit is configured to abide by scheduling rules, and capacity for each resource. In at least one example, the resource scheduling control unit also accounts for various factors, including time spent in training, usage of external devices, travel to external sites, quality aspects, such as timing of rest and rest-days, and/or the like. The resource scheduling control unit can also base schedules on limited availability of external resources, such as time and availability of evaluators. The resource scheduling control unit can also schedule a mix of internal and external training demands to determine availability and capacity for various courses.

Examples of the present disclosure provide systems and methods that solve various issues experienced by typical known manual scheduling processes. The systems and methods described herein are automatic, and quickly generate schedules. Further, the systems and methods reduce the need for hiring and/or training specialists. Also, recurrent training for pilots often competes for the same resources as longer qualification trainings. As recurrent courses are typically released for bidding at a fixed time, such deadline could otherwise lock slots for recurrent training prior to initial qualification training, which can otherwise create costly delays to the trainee undergoing qualification training. The systems and methods described herein account for such recurrent and qualification training, and can schedule and revise accordingly. For example, fast (for example, within hours, minutes, or even seconds, instead of weeks) automatic scheduling allows for integration with various training plans. Speeding up the training scheduling process allows for validation and fine-tuning of the plan. The systems and methods described herein provide improved training throughput.

Further, the systems and methods described herein can account for a sequence of events (modules) for a trainee, with modules being scheduled in a fixed order. The different modules can use different slots of compatible training devices, and a training device can be used for different types of modules, depending on the trainee requirement. Also, trainees can be paired up in a particular course for certain modules and therefore share the same device and instructor, while in some cases the module may require splitting the trainees up for using different instructors and devices.

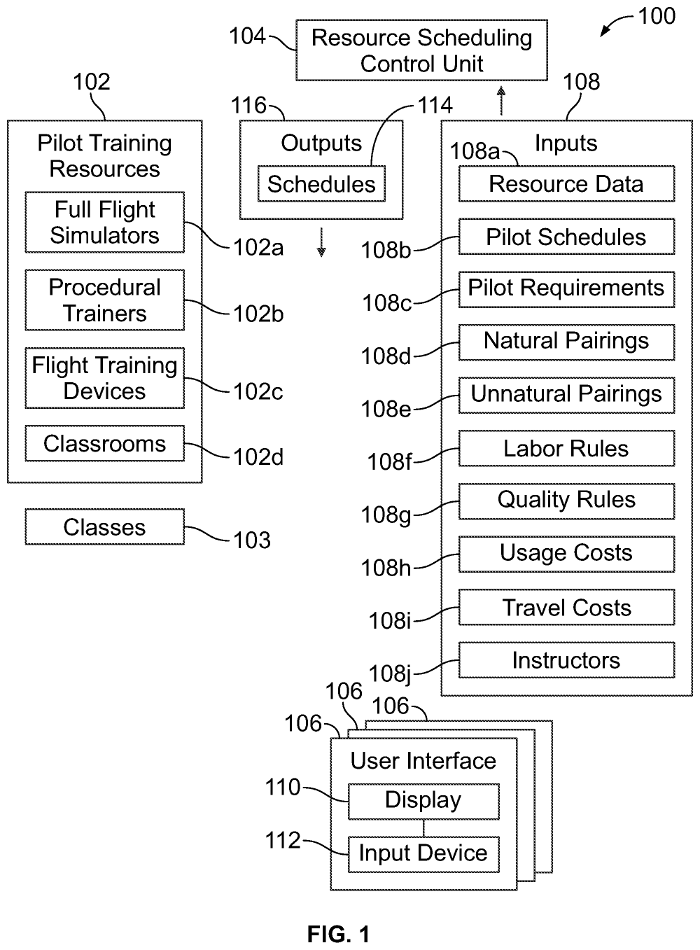

FIG. 1 illustrates a schematic block diagram a system 100 for scheduling pilot training resources 102, according to an example of the present disclosure. The pilot training resources 102 include various systems, devices, locations, and the like for training individuals (such as current pilots, trainees, students, and the like) to operate aircraft. Examples of the pilot training resources 102 include full flight simulators 102a, such as a replica of a cockpit or flight deck of an aircraft, procedural trainers 102b, such as computer workstations, flight training devices 102c, such as physical and/or electronic components based on aircraft operations, classrooms 102d (whether physical classrooms, virtual on-line classrooms, or the like), and/or the like.

Classes 103 are part of a curriculum. For example, classes 103 includes flight modules required for training, certification, continuing education, and/or the like), and/or the like. The classes 103 are part of a curriculum definition that maps the requirement of training for each individual onto a list of required modules. Each module has a requirement on a training resource (for instance, full simulator training module requires a full flight simulator).

The system 100 also includes a resource scheduling control unit 104, which is in communication with one or more systems (such as electronic databases, computers, and/or the like) that provide data regarding the availability and capacity of the pilot training resources 102. The resource scheduling control unit 104 is in communication with one or more user interfaces 106, which are used to provide the data regarding the pilot training resources 102. For example, the user interface(s) 106 are used to provide inputs 108 to the resource scheduling control unit 104. The inputs 108 can include the data regarding the pilot training resources 102.

The resource scheduling control unit 104 is in communication with the user interface(s) 106, such as through one or more wired or wireless connections, web- or cloud-based connections, a private communication network, and/or the like. In at least one example, the resource scheduling control unit 104 and one or more of the user interfaces 106 are co-located. For example, the resource scheduling control unit 104 and the user interface(s) 106 can be part of a computing device or system. As another example, the resource scheduling control unit 104 and the user interface 106 can be remotely located from one another.

In at least one example, a user interface 106 includes a display 110 and an input device 112, both of which can be in communication with the resource scheduling control unit 104, such as through one or more wired or wireless connections, web- or cloud-based connections, a private communication network, and/or the like. The display 110 can be an electronic monitor, electronic screen, television, touchscreen, and/or the like. The input device 112 can include a keyboard, mouse, stylus, touchscreen interface (that is, the input device 112 can be integral with the display 110), and/or the like.

The user interfaces 106 are configured to electronically send the inputs 108 to the resource scheduling control unit 104. That is, the inputs 108 are electronic signals including data that includes information regarding pilots and pilot training resources. The inputs 108 include various information related to scheduling of the pilot training resources 102. For example, the inputs 108 include resource data 108a that includes information regarding the availability and capacity for the pilot training resources 102.

The inputs 108 also pilot schedules 108b for the various pilots (including current pilots, student pilots, trainee pilots, and the like). The pilot schedules 108b can include times and dates when the pilots are not available for scheduling.

The inputs 108 also include pilot requirements 108c for each of the pilots. The pilot requirements 108c include information regarding training already complete, and training that still needs to be completed for the pilots.

In at least one example, the inputs 108 also include natural pairings 108d, which include information as to individual pilots who can train together in relation to a particular pilot training resource 102. For example, a natural pairing 108d includes a particular captain and first officer who are able to and/or otherwise required to train together at the same with respect to a particular pilot training resource 102, such as a full flight simulator 108a.

In at least one example, the inputs 108 also include unnatural pairings 108e, which include information as to individual pilots who may, or are precluded from (that is, cannot), training together in relation to a particular pilot training resource 102. As an example, two or more captains can be scheduled for a particular class 103 (for example, module). As another example, two or more first officers may be precluded from a particular full flight simulator 108a and/or procedural trainer 102b at the same time.

In at least one example, the inputs 108 also include labor rules 108f, which include information as to when individuals can be scheduled for certain pilot training resources 102. As an example, if an individual is scheduled for a full flight simulator 108a at a particular time, a labor rule (such as a pilot union agreement) may preclude the individual from one or more particular training resources 102 and/or classes 103 within a predetermined time of the scheduled time for the full flight simulator 108a.

In at least one example, the inputs 108 also include quality rules 108g, which include information as to a particular quality level for a certain pilot training resource for a particular training requirement. As an example, an initial flight simulation can be performed on a procedural trainer 102b, while a final flight simulation is to be performed on a full flight simulator 108a. As another example, an entry level class 103 can be instructed by a basic level instructor having a certain level of flight experience, while an advanced level class 103 is to be instructed by an advanced instructor having a further advanced level of flight experience.

In at least one example, the inputs 108 also include usage costs 108h, which includes information regarding the time and monetary cost for the pilot training resources 102. For example, a full flight simulator 108a requires a certain amount of time and money to operate for a training simulation.

In at least one example, the inputs 108 also include travel costs 108i, which includes information regarding the cost for a pilot to travel to a location for a particular pilot training resource 102. For example, an individual pilot may need to travel to a destination for a full flight simulator 108a, a classroom 102d, and/or the like.

In at least one example, the inputs 108 also include instructors 108j, which include information regarding qualification and availability for instructors for the pilot training resources 102. For example, a particular class 103 may require an instructor having a particular education and/or flight experience level. For a limited amount of such instructors may be available to provide instruction during such class 103.

In operation, the user interface(s) 106 are used to provide the inputs 108 for the various pilots. For example, numerous user interfaces 106 can be used to provide the inputs 108 for dozens, hundreds, thousands, or more pilots who need to be scheduled in relation to the pilot training resources 102. The resource scheduling control unit 104 receives the inputs 108 from the user interface(s) 106. After receiving the inputs 108, the resource scheduling control unit 104 compares the inputs to generate schedules for each of the pilots. The resource scheduling control unit 104 reviews the inputs 108, including pilot availability, pilot training resource availability and capacity, and the like, to generate the schedules 114 for the pilots. The resource scheduling control unit 104 generates the schedules to comply with the resource data 108a, the pilot schedules 108b, the pilot requirements 108c, natural pairings 108d, unnatural pairings 108e, labor rules 108f, quality rules 108g, usage costs, travel costs 108i, instructors 108j, and/or the like. For example, the resource scheduling control unit 104 discards scheduling a time slot for a pilot for a full flight simulator 108a if the pilot is required to attend a class 103 at the time slot, and/or if such a time slot would violate a labor rule 108f, a natural pairing 108d, or an unnatural pairing 108e.

The resource scheduling control unit 104 receives the inputs 108, and generates the schedules 114. After the resource scheduling control unit 104 generates the schedules 114 for the pilots, the resource scheduling control unit 104 sends one or more outputs 116 including schedules 114 to the user interface(s) 106. The outputs 116 are electronic signals that include information, such as the schedules 114. The user interface(s) 106 can then show schedules 114 for the pilots, as generated by the resource scheduling control unit 104, on the display(s) 110.

As described herein, the system 100 includes the resource scheduling control unit 104 that automatically schedules the pilot training resources 102 for pilots. The resource scheduling control unit 104 generates the schedules 114 for the pilots. In at least one example, the schedules 114 include course module sequences (for example, required sequences for particular classes 103) for both named and anonymous pilots, which can be mapped to training device slots. The resource scheduling control unit 104 is configured to abide by scheduling rules, and capacity for each pilot training resource 102. The resource scheduling control unit 104 can also account for various factors, including time spent in training, usage of external devices, travel to external sites, quality aspects, such as timing of rest and rest-days, and/or the like.

As described herein, the system 100 includes the resource scheduling control unit 104, which is configured to receive the inputs 108 including information regarding pilots and the pilot training resources 102. The resource scheduling control unit 104 is further configured generate the schedules 114 for the pilots based on the inputs 108. The resource scheduling control unit 104 is further configured to output the schedules 114 to one or more user interfaces 106.

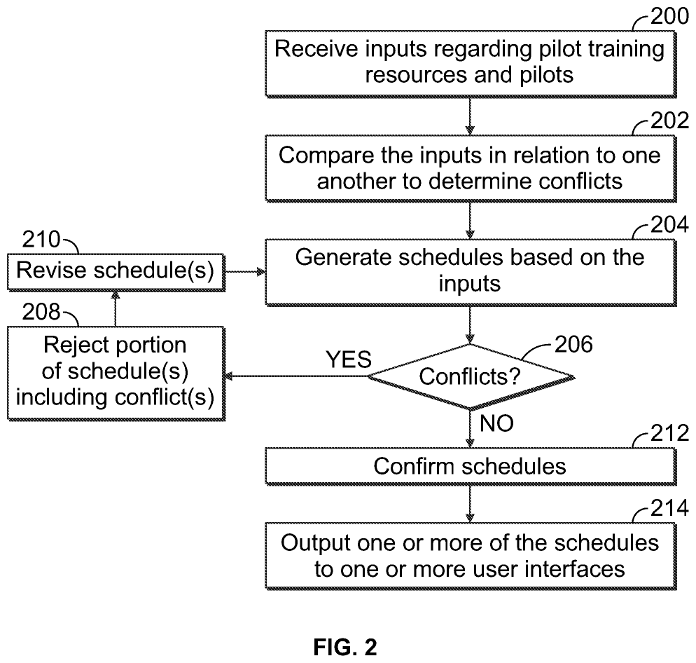

FIG. 2 illustrates a flow chart of a method for scheduling pilot training resources, according to an example of the present disclosure. Referring to FIGS. 1 and 2, at 200, the resource scheduling control unit 104 receives the inputs 108 regarding the pilot training resources 102 and the pilots, such as from one or more of the user interfaces 106. At 202, the resource scheduling control unit 104 compares the inputs in relation to one another to determine conflicts, such as times when pilots may not be scheduled, times when pilot training resources 102 may not be scheduled, times when pilots are already scheduled for a particular pilot training resource 102, times when pilot training resources 102 are already scheduled, and/or the like.

At 204, the resource scheduling control unit 104 generates schedules for the pilots and the pilot training resources 102 based on the inputs 108. For example, the resource scheduling control unit 104 generates a schedule 114 for a pilot in relation to a plurality of the pilot training resources 102. As another example, the resource scheduling control unit 104 generates dozens, hundreds, thousands or more of schedules 114 for dozens, hundreds, thousands or more of pilots in relation to numerous pilot training resources 102.

At 206, the resource scheduling control unit 104 determines if there are any conflicts within the schedules 114. If there is at least one conflict, the method proceeds from 206 to 208, at which the resource scheduling control unit 104 rejects the portion of the schedule(s) 114 including the conflict(s). Next, at 210, the resource scheduling control unit 104 revises the schedule(s) 210 to remove the conflict(s). The method then returns to 204.

If there are no conflicts at 206, however, the method proceeds from 206 to 212, at which the resource scheduling confirms the schedules 114 (for example, finalizes the schedules 114, and confirms the schedules 114 are valid and abide by all necessary rules, regulations, availability, capacity, and the like). At 214, the resource scheduling control unit 104 then outputs one or more of the schedules 114 to one or more user interface(s) 106, which can then show the schedule(s) 114 on the display(s) 110.

Certain examples of the present disclosure provide a method configured to minimize or otherwise reduce scheduling costs. In at least one example, the method is based on column generation from an integer linear programming domain.

A cost of a student schedule includes actual costs (such as travel costs, external simulator cost, and the like) in addition to auxiliary costs intended to improve quality of schedules. For example, training that is completed in five days instead of eight days is preferred as the pilot is able to return to line flying duty earlier, and therefore has a lower cost component. As another example, training can be at irregular times per day, which may be permitted in terms of regulations, but may impact quality of life, and therefore yield a higher cost component compared to a more regular schedule. Examples of the present disclosure are configured to adjust a relation between these auxiliary costs in order to obtain schedules that fulfill the desired need of an aircraft operator. Each schedule may also have a well-defined cost that may not affect the schedules of other individuals.

In at least one example, the resource scheduling control unit 104, in an iterative process, can assign each individual or individual pair (such as a natural pairing) a schedule at a certain cost or left unassigned, which may generate a penalty cost. The resource scheduling control unit 102 may initially not assign the individuals. During each iteration, the resource scheduling control unit 104 can generate low cost schedules for each individuals. The cost can include the schedule cost, and also a penalty cost for schedules utilizing previously assigned slots (which can change for each iteration). After the resource scheduling control unit 104 has generated schedules for all relevant individuals, the resource scheduling control unit 104 can then select an overall minimal cost assignment such that no slots are over-assigned. The resource scheduling control unit 104 may then proceed with a new iteration including another generation and assignment step, and continue such iterations until no substantial cost improving in cost is made.

In at least one example, the resource scheduling control unit 104 generates schedules for pairs of individuals (such as a natural pairing of a captain and first officer), instead of a straight forward column generation application. For unnatural pairings, the resource scheduling control unit 104 generates schedules for each individuals that can diverge at certain points and converge again at others, such as may be dictated by training curriculum.

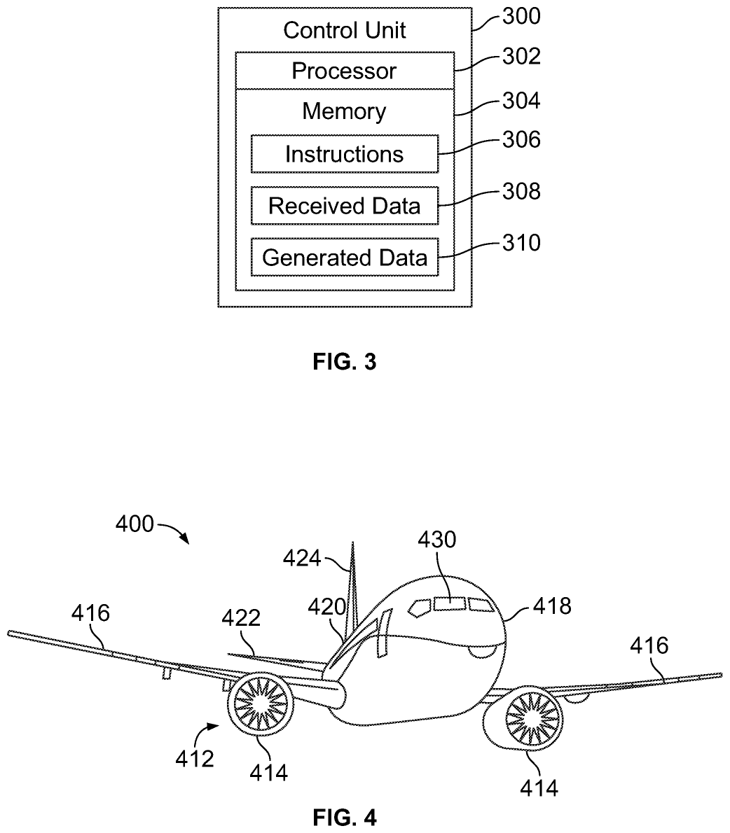

FIG. 3 illustrates a schematic block diagram of a control unit 300, according to an example of the present disclosure. In at least one example, the resource scheduling control unit 104 shown in FIG. 1 is configured as shown and described with respect to the control unit 300. The control unit 300 includes at least one processor 302 in communication with a memory 304. The memory 304 stores instructions 306, received data 308, and generated data 310. The control unit 300 shown in FIG. 3 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the resource scheduling control unit 104 can be or include one or more processors that are configured to control operation, as described herein.

The resource scheduling control unit 104 is configured to execute a set of instructions that are stored in one or more data storage units or elements (such as one or more memories), in order to process data. For example, the resource scheduling control unit 104 can include or be coupled to one or more memories. The data storage units can also store data or other information as desired or needed. The data storage units can be in the form of an information source or a physical memory element within a processing machine.

The set of instructions may include various commands that instruct the resource scheduling control unit 104 as a processing machine to perform specific operations such as the methods and processes of the various examples of the subject matter described herein. The set of instructions can be in the form of a software program. The software can be in various forms such as system software or application software. Further, the software can be in the form of a collection of separate programs, a program subset within a larger program, or a portion of a program. The software can also include modular programming in the form of object-oriented programming. The processing of input data by the processing machine may be in response to user commands, or in response to results of previous processing, or in response to a request made by another processing machine.

The diagrams of examples herein illustrate one or more control or processing units, such as the resource scheduling control unit 104. It is to be understood that the processing or control units can represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware can include state machine circuitry hardwired to perform the functions described herein. Optionally, the hardware can include electronic circuits that include and/or are connected to one or more logic-based devices, such as microprocessors, processors, controllers, or the like. Optionally, the resource scheduling control unit 104 can represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms can include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-3, examples of the present disclosure provide systems and methods that allow large amounts of data to be quickly and efficiently analyzed by a computing device. For example, the resource scheduling control unit 104 can analyze hundreds, thousands, or more inputs regarding schedules, pilot training resources, and the like. As such, large amounts of data, which may not be readily and easily discernable by human beings, are being tracked and analyzed. The vast amounts of data are efficiently organized and/or analyzed by the resource scheduling control unit 104, as described herein. The resource scheduling control unit 104 analyzes the data in a relatively short time (such as within hours, minutes, or even seconds, instead of weeks, as is the case with conventional scheduling) in order to quickly and efficiently determine and manage training schedules for pilots. A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, components of the system 100, such as the resource scheduling control unit 104, provide and/or enable a computer system to operate as a special computer system for determining, generating, and managing training schedules for pilots in relation to pilot training resources 102. The resource scheduling control unit 104 improves upon standard computing devices by determining, generating, and managing such schedules in an efficient and effective manner.

In at least one example, all or part of the systems and methods described herein may be or otherwise include an artificial intelligence (AI) or machine-learning system that can automatically perform the operations of the methods also described herein. For example, the resource scheduling control unit 104 can be an artificial intelligence or machine learning system. These types of systems may be trained from outside information and/or self-trained to repeatedly improve the accuracy with how data is analyzed to monitor, track, revise, and update schedules for pilots in relation to pilot training resources. Over time, these systems can improve by monitoring, tracking, revising, and updating schedules with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination schedules. The training minimizes conflicts and interference by performing an iterative training algorithm, in which the systems are retrained with an updated set of data and based on the feedback examined prior to the most recent training of the systems. This provides a robust analysis model that can better determine schedules in a cost effective, efficient, and overall effective manner.

FIG. 4 illustrates a perspective front view of an aircraft 400, according to an example of the present disclosure. The aircraft 400 includes a propulsion system 412 that includes engines 414, for example. Optionally, the propulsion system 412 may include more engines 414 than shown. The engines 414 are carried by wings 416 of the aircraft 400. In other examples, the engines 414 may be carried by a fuselage 418 and/or an empennage 420. The empennage 420 may also support horizontal stabilizers 422 and a vertical stabilizer 424. The fuselage 418 of the aircraft 400 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 4 shows an example of an aircraft 400. It is to be understood that the aircraft 400 can be sized, shaped, and configured differently than shown in FIG. 4.

The systems and methods described herein are configured to automatically generate schedules for pilots in relation to various pilot training resources 102 that are used to train the pilots to operate aircraft, such as the aircraft 400. As an example, a full flight simulator 102a is a physical structure including a replica of a cockpit of the aircraft 400, including the same instrumentation, displays, controls, and the like.

Further, the disclosure comprises examples according to the following clauses:
Clause 1. A system comprising:
a resource scheduling control unit configured to:
   receive inputs including information regarding pilots and pilot training resources,
   generate schedules for the pilots based on the inputs, and
   output the schedules to one or more user interfaces.
   Clause 2. The system of Clause 1, wherein the pilot training resources comprise one or more of:
full flight simulators;
procedural trainers;
flight training devices; or
classrooms.
   Clause 3. The system of Clause 1, wherein the pilot training resources comprise:
full flight simulators;
procedural trainers;
flight training devices; and
classrooms.
   Clause 4. The system of any of Clauses 1-3, wherein the inputs comprise resource data including information regarding availability and capacity for the pilot training resources.
   Clause 5. The system of any of Clauses 1-4, wherein the inputs comprise times and dates when the pilots are not available for scheduling.
   Clause 6. The system of any of Clauses 1-5, wherein the inputs comprise information regarding training already complete, and training that still needs to be completed for the pilots.
   Clause 7. The system of any of Clauses 1-6, wherein the inputs comprise information as to individual pilots who can, or cannot, train together in relation to one or more of pilot training resources.
   Clause 8. The system of any of Clauses 1-7, wherein the inputs comprise labor rules.
   Clause 9. The system of any of Clauses 1-8, wherein the inputs comprise quality rules.
   Clause 10. The system of any of Clauses 1-9, wherein the inputs comprise usage costs.
   Clause 11. The system of any of Clauses 1-10, wherein the inputs comprise travel costs.
   Clause 12. The system of any of Clauses 1-11, wherein the inputs comprise qualification and availability for instructors for one or more of the pilot training resources.
   Clause 13. The system of any of Clauses 1-3, wherein the inputs comprise:
resource data including information regarding availability and capacity for the pilot training resources;
times and dates when the pilots are not available for scheduling;
information regarding training already complete, and training that still needs to be completed for the pilots;
information as to individual pilots who can, or cannot, train together in relation to one or more of pilot training resources;
labor rules;
quality rules;
usage costs;
travel costs; and
qualification and availability for instructors for one or more of the pilot training resources.
   Clause 14. A method comprising:
receiving, by a resource scheduling control unit, inputs including information regarding pilots and pilot training resources;
generating, by the resource scheduling control unit, schedules for the pilots based on the inputs; and
outputting, by the resource scheduling control unit, the schedules to one or more user interfaces.
   Clause 15. The method of Clause 14, wherein the pilot training resources comprise one or more of:
full flight simulators;
procedural trainers;
flight training devices; or
classrooms.
   Clause 16. The method of Clause 14, wherein the pilot training resources comprise:
full flight simulators;
procedural trainers;
flight training devices; and
classrooms.
   Clause 17. The method of any of Clauses 14-16, wherein the inputs comprise one or more of:
resource data including information regarding availability and capacity for the pilot training resources;
times and dates when the pilots are not available for scheduling;
information regarding training already complete, and training that still needs to be completed for the pilots;
information as to individual pilots who can, or cannot, train together in relation to one or more of pilot training resources;
labor rules;
quality rules;
usage costs;
travel costs; or
qualification and availability for instructors for one or more of the pilot training resources.
   Clause 18. The method of any of Clauses 14-16, wherein the inputs comprise:
resource data including information regarding availability and capacity for the pilot training resources;
times and dates when the pilots are not available for scheduling;
information regarding training already complete, and training that still needs to be completed for the pilots;
information as to individual pilots who can, or cannot, train together in relation to one or more of pilot training resources;
labor rules;
quality rules;
usage costs;
travel costs; and
qualification and availability for instructors for one or more of the pilot training resources.
   Clause 19. A non-transitory computer-readable storage medium comprising executable instructions that, in response to execution, cause one or more control units comprising a processor, to perform operations comprising:
receiving inputs including information regarding pilots and pilot training resources;
generating schedules for the pilots based on the inputs; and
outputting the schedules to one or more user interfaces.
   Clause 20. The non-transitory computer-readable storage medium of Clause 19, wherein the pilot training resources comprise full flight simulators, procedural trainers, flight training devices, and classrooms, and wherein the inputs comprise resource data including information regarding availability and capacity for the pilot training resources, times and dates when the pilots are not available for scheduling, information regarding training already complete, and training that still needs to be completed for the pilots, information as to individual pilots who can, or cannot, train together in relation to one or more of pilot training resources, labor rules, quality rules, usage costs, travel costs, and qualification and availability for instructors for one or more of the pilot training resources.

As described herein, examples of the present disclosure provide systems and methods for efficiently, effectively, and optimally scheduling pilot training resources for individuals. The systems and methods described herein address the problem of complex operator training requirements in view of restrictive scheduling and resource constraints.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a resource scheduling control unit configured to:
receive inputs including information regarding pilots and pilot training resources,
generate schedules for the pilots based on the inputs, and
output the schedules to one or more user interfaces.

2. The system of claim 1, wherein the pilot training resources comprise one or more of:
full flight simulators;
procedural trainers;
flight training devices; or
classrooms.

3. The system of claim 1, wherein the pilot training resources comprise:
full flight simulators;
procedural trainers;
flight training devices; and
classrooms.

4. The system of claim 1, wherein the inputs comprise resource data including information regarding availability and capacity for the pilot training resources.

5. The system of claim 1, wherein the inputs comprise times and dates when the pilots are not available for scheduling.

6. The system of claim 1, wherein the inputs comprise information regarding training already complete, and training that still needs to be completed for the pilots.

7. The system of claim 1, wherein the inputs comprise information as to individual pilots who can, or cannot, train together in relation to one or more of pilot training resources.

8. The system of claim 1, wherein the inputs comprise labor rules.

9. The system of claim 1, wherein the inputs comprise quality rules.

10. The system of claim 1, wherein the inputs comprise usage costs.

11. The system of claim 1, wherein the inputs comprise travel costs.

12. The system of claim 1, wherein the inputs comprise qualification and availability for instructors for one or more of the pilot training resources.

13. The system of claim 1, wherein the inputs comprise:
resource data including information regarding availability and capacity for the pilot training resources;
times and dates when the pilots are not available for scheduling;
information regarding training already complete, and training that still needs to be completed for the pilots;
information as to individual pilots who can, or cannot, train together in relation to one or more of pilot training resources;
labor rules;
quality rules;
usage costs;
travel costs; and
qualification and availability for instructors for one or more of the pilot training resources.

14. A method comprising:
receiving, by a resource scheduling control unit, inputs including information regarding pilots and pilot training resources;
generating, by the resource scheduling control unit, schedules for the pilots based on the inputs; and
outputting, by the resource scheduling control unit, the schedules to one or more user interfaces.

15. The method of claim 14, wherein the pilot training resources comprise one or more of:
full flight simulators;
procedural trainers;
flight training devices; or
classrooms.

16. The method of claim 14, wherein the pilot training resources comprise:
full flight simulators;
procedural trainers;
flight training devices; and
classrooms.

17. The method of claim 14, wherein the inputs comprise one or more of:
resource data including information regarding availability and capacity for the pilot training resources;
times and dates when the pilots are not available for scheduling;
information regarding training already complete, and training that still needs to be completed for the pilots;
information as to individual pilots who can, or cannot, train together in relation to one or more of pilot training resources;
labor rules;
quality rules;
usage costs;
travel costs; or
qualification and availability for instructors for one or more of the pilot training resources.

18. The method of claim 14, wherein the inputs comprise:
resource data including information regarding availability and capacity for the pilot training resources;
times and dates when the pilots are not available for scheduling;
information regarding training already complete, and training that still needs to be completed for the pilots;
information as to individual pilots who can, or cannot, train together in relation to one or more of pilot training resources;
labor rules;
quality rules;
usage costs;
travel costs; and
qualification and availability for instructors for one or more of the pilot training resources.

19. A non-transitory computer-readable storage medium comprising executable instructions that, in response to execution, cause one or more control units comprising a processor, to perform operations comprising:
receiving inputs including information regarding pilots and pilot training resources;
generating schedules for the pilots based on the inputs; and
outputting the schedules to one or more user interfaces.

20. The non-transitory computer-readable storage medium of claim 19, wherein the pilot training resources comprise full flight simulators, procedural trainers, flight training devices, and classrooms, and wherein the inputs comprise resource data including information regarding availability and capacity for the pilot training resources, times and dates when the pilots are not available for scheduling, information regarding training already complete, and training that still needs to be completed for the pilots, information as to individual pilots who can, or cannot, train together in relation to one or more of pilot training resources, labor rules, quality rules, usage costs, travel costs, and qualification and availability for instructors for one or more of the pilot training resources.
